(19) United States
(12) Patent Application Publication
(10) Pub. No.: US 2019/0172075 A1
(43) Pub. Date: Jun. 6, 2019

(54) Maintaining Dynamic Product Catalogs By Tracking Current Trends

(71) Applicant: International Business Machines Corporation, Armonk, NY (US)

(72) Inventors: Sreyash D. Kenkre, Bangalore (IN); Indrajit Bhattacharya, Kolkata (IN); Vikas C. Raykar, Bangalore (IN); VINAYAKA PANDIT, Bangalore (IN)

(21) Appl. No.: 15/828,761

(22) Filed: Dec. 1, 2017

(51) Int. Cl. G06Q 30/02; G06Q 50/00; G06F 17/30

(52) U.S. Cl. CPC G06Q 30/0201; G06Q 50/01; G06F 17/30663; G06F 17/30994; G06F 17/30958; G06Q 30/0269

(57) ABSTRACT

Input from a user is received about a product of interest to the user. A plurality of sources that monitor product trends is determined. The plurality of sources is ranked. A plurality of key concepts associated with the product of interest are extracted from the ranked sources. Relationships are extracted from the key concepts. A plurality of triples between the key concepts and the relationships are created. Each triple in the plurality of triples is weighted based on the ranking of the sources.

### BACKGROUND

The present invention relates generally to the field of product catalogs, and more particularly to maintaining product catalogs by tracking current trends.

Product catalogs are available in both hardcopy (i.e., printed) form and softcopy (i.e., online) form. A hardcopy catalog may be sent to a user once a year, once every six months, monthly during the Holiday season, or on any frequency decided by the owner of the catalog. A softcopy catalog is available twenty-four hours a day, seven days a week. Depending on the product line, a catalog may be a few pages in length or hundreds of pages long.

### SUMMARY OF THE INVENTION

Embodiments of the present invention include an approach for maintaining a product catalog by tracking current trends. In one embodiment, input from a user is received about a product of interest to the user. A plurality of sources that monitor product trends is determined. The plurality of sources is ranked. A plurality of key concepts associated with the product of interest are extracted from the ranked sources. Relationships are extracted from the key concepts. A plurality of triples between the key concepts and the relationships are created. Each triple in the plurality of triples is weighted based on the ranking of the sources.

### BRIEF DESCRIPTION OF THE DRAWINGS

FIG. 1 depicts a functional block diagram of a computing environment, in accordance with an embodiment of the present invention;

FIG. 2 depicts a flowchart of a program for maintaining a product catalog by tracking current trends, in accordance with an embodiment of the present invention; and

FIG. 3 depicts a block diagram of components of the computing environment of FIG. 1, in accordance with an embodiment of the present invention.

### DETAILED DESCRIPTION

Embodiments of the present invention provide for maintaining a product catalog by tracking current trends. Current product catalog maintenance is a slow and tedious process with a lot of human interaction. Updating a product catalog is a large endeavor usually done manually by a product manager so an update may only happen once a quarter. However, new products become available on an almost daily basis. As a result, a catalog can become outdated resulting in lost customers and lost sales. Positive reviews of a new product can “go viral” creating a large demand for the new product. In addition to reviews, popular bloggers can also create a large demand for a new product just be mentioning the product in a blog posting. If a consumer cannot find a desired new product in catalog ‘A’ from the company that the consumer normally frequents, the consumer may turn to a catalog ‘B’ of a different company to purchase the new product.

Embodiments of the present invention recognize that there is an approach for maintaining a product catalog by tracking current trends. In an embodiment, social media sites can be ranked based on popularity, importance, etc. A corpus of highly ranked social media sites can be monitored to capture product related information. Key concepts can be extracted from the captured information and relationships can be built between the concepts. The relationships can be used to form “triples” between the concepts. The triples can be weighted based on the source and the weighted triples can be used to create knowledge graphs which, when used in concert with existing knowledge bases, can be used to identify new relationships that are relevant to a user.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

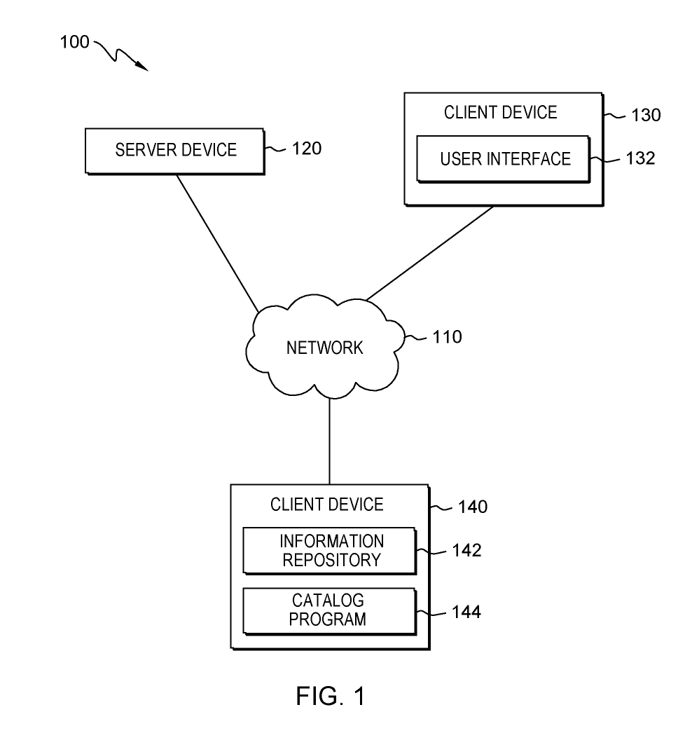

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes server device 120, computing device 130, and client device 140, interconnected via network 110. In example embodiments, computing environment 100 may include other computing devices (not shown in FIG. 1) such as smart watches, cell phones, smartphones, wearable technology, phablets, tablet computers, laptop computers, desktop computers, other computer servers or any other computer system known in the art, interconnected to server device 120 computing device 130, and client device 140, over network 110.

In an embodiment of the present invention, server device 120, computing device 130, and client device 140 connect to network 110, which enables server device 120, computing device 130, and client device 140 to access other computing devices and/or data not directly stored on server device 120, computing device 130, and client device 140. Network 110 may be, for example, a short-range, low power wireless connection, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between server device 120, computing device 130, client device 140, and any other computing devices connected to network 110, in accordance with embodiments of the present invention. In an embodiment, data received by another computing device (not shown in FIG. 1) in computing environment 100 may be communicated to server device 120, computing device 130, and client device 140 via network 110.

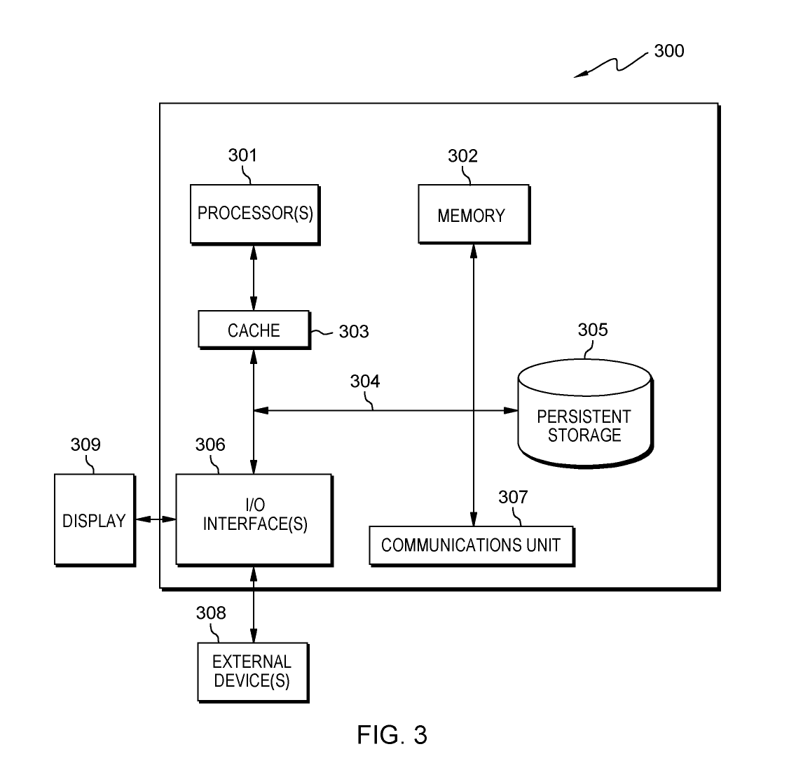

In an embodiment, server device 120 is a computing device that hosts a plurality of product catalogs and social media websites. According to an embodiment of the present invention, server device 120 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, server device 120 represents a computer system utilizing clustered computers and components (e.g., database server computers, application server computers, etc.) that act as a single pool of seamless resources when accessed by elements of computing environment 100. In general, server device 120 is representative of any electronic device or combination of electronic devices capable of executing computer readable program instructions. In an embodiment, computing environment 100 includes any number of server device 120. Server device 120 includes components as depicted and described in further detail with respect to FIG. 3, in accordance with embodiments of the present invention.

According to an embodiment of the present invention, computing device 130 is a computing device used by a user to access product catalogs and social media websites. In an embodiment computing device 130 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, computing device 130 represents a computer system utilizing clustered computers and components (e.g., database server computers, application server computers, etc.) that act as a single pool of seamless resources when accessed by elements of computing environment 100. In general, computing device 130 is representative of any electronic device or combination of electronic devices capable of executing computer readable program instructions. In an embodiment, computing environment 100 includes any number of computing device 130. Computing device 130 includes components as depicted and described in further detail with respect to FIG. 3, in accordance with embodiments of the present invention.

According to an embodiment of the present invention, computing device 130 includes user interface 132. In an embodiment, user interface 132 provides an interface between a user of computing device 130, network 110, and any other devices connected to network 110 such as server device 120 and client device 140. User interface 132 allows a user of computing device 130 to interact with the Internet and also enables the user to receive an indicator of one or more previous viewing locations and a summary of viewing history on the Internet. In general, a user interface is the space where interactions between humans and machines occur. User interface 132 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 132 may also be mobile application software that provides an interface between a user of computing device 130 and network 110. Mobile application software, or an “app,” is a computer program designed to run on smartphones, phablets, tablet computers and other mobile devices.

According to an embodiment of the present invention, client device 140 is a computing device used to maintain product catalogs. In an embodiment, client device 140 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, client device 140 represents a computer system utilizing clustered computers and components (e.g., database server computers, application server computers, etc.) that act as a single pool of seamless resources when accessed by elements of computing environment 100. In general, client device 140 is representative of any electronic device or combination of electronic devices capable of executing computer readable program instructions. In an embodiment, computing environment 100 includes any number of client device 140. Client device 140 includes components as depicted and described in further detail with respect to FIG. 3, in accordance with embodiments of the present invention. In an embodiment, server device 120, computing device 130, and client device 140 are substantially similar to one another.

According to an embodiment of the present invention, client device 140 includes information repository 142 and catalog program 144. In an embodiment, information repository 142 may be storage that may be written to and/or read by catalog program 144. In one embodiment, information repository 142 resides on client device 140. In another embodiment, information repository 142 may reside on server device 120, computing device 130, or any other device (not shown in FIG. 1) in computing environment 100, in cloud storage or on another computing device accessible via network 110. In yet another embodiment, information repository 142 may represent multiple storage devices within client device 140. Examples of data stored to information repository 142 include a plurality of social media websites, extracted keywords, relationships between extracted keywords, triples concerning products in a catalog, and recommendations.

In an embodiment, information repository 142 may be implemented using any volatile or non-volatile storage media for storing information, as known in the art. For example, information repository 142 may be implemented with a tape library, optical library, one or more independent hard disk drives, multiple hard disk drives in a redundant array of independent disks (RAID), solid-state drives (SSD), or random-access memory (RAM). Similarly, information repository 142 may be implemented with any suitable storage architecture known in the art, such as a relational database, an object-oriented database, or one or more tables. According to an embodiment of the present invention, catalog program 144 and any other programs and applications (not shown in FIG. 1) operating on client device 140 may store, read, modify, or write data to information repository 142.

According to embodiments of the present invention, catalog program 144 is a program, a subprogram of a larger program, an application, a plurality of applications, or mobile application software, which functions to track trends for maintaining a product catalog. A program is a sequence of instructions written by a programmer to perform a specific task. In an embodiment, catalog program 144 extracts key concepts from ranked social media websites and determines relationships between the key concepts. In the embodiment, the relationships are used to form triples between the concepts. Further in the embodiment, the triples are weighted, the weighted triples are used to form a knowledge graph, and the newly formed knowledge graph is embedded into an existing knowledge base. Further yet in the embodiment, new relationships are identified based in the embedded triples. Catalog program 144 may run by itself but may be dependent on system software (not shown in FIG. 1) to execute. In one embodiment, catalog program 144 functions as a stand-alone program residing on client device 140. In another embodiment, catalog program 144 may work in conjunction with other programs, applications, etc., found on client device 140 or on any other device in computing environment 100. In yet another embodiment, catalog program 144 may be found on server device 120, computing device 130, or on other computing devices (not shown in FIG. 1) in computing environment 100, which are interconnected to client device 140 via network 110.

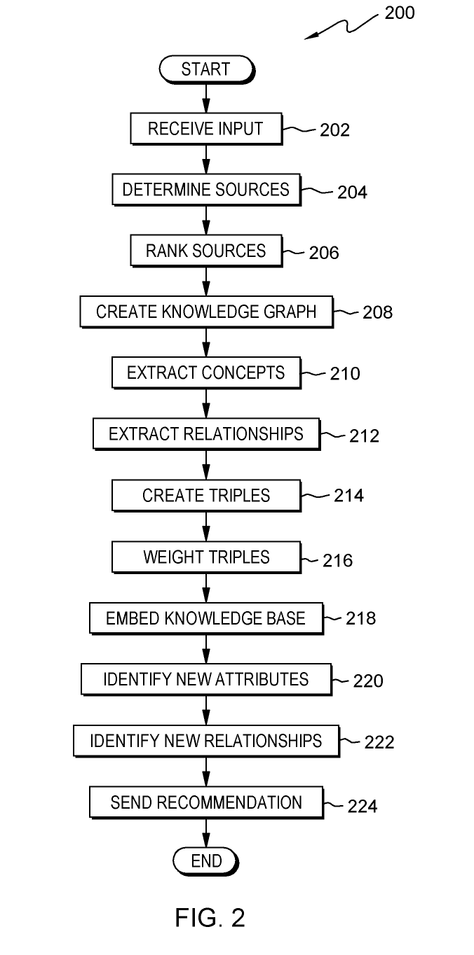

FIG. 2 is a flowchart of workflow 200 depicting an approach for tracking trends to maintain a product catalog. In one embodiment, the method of workflow 200 is performed by catalog program 144. In an alternative embodiment, the method of workflow 200 may be performed by any other program working with catalog program 144. In an embodiment, a user may invoke workflow 200 upon powering on client device 140. In an alternative embodiment, a user may invoke workflow 200 upon accessing catalog program 144.

In an embodiment, catalog program 144 receives input (step 202). In other words, catalog program 144 receives input from a user of a product of interest to the user found in a product catalog. In an embodiment, catalog program 144 receives the input via any input device known in the art such as a keyboard, a touchscreen, a microphone, etc. In an embodiment, catalog program 144 receives an input from a user of client device 140 who is entering the input via a keyboard and user interface 132. For example, “Joe” is interested in high quality socks for hunting and fishing that are warm, lightweight, and breathable.

In an alternative embodiment, catalog program 144 performs the steps below independent of an input from a user as the initial step. In the alternative embodiment, a knowledge graph (KG) can be created, the KG can be embedded into an existing knowledge base to identify new attributes and new relationships, and the knowledge base, new attributes, and new relationships can be stored to a memory (steps described in detail below). Further in the alternative embodiment, a user can input a query about a product and catalog program 144 can retrieve the knowledge base, new attributes, and new relationships to provide the user with a recommendation.

In an embodiment, catalog program 144 determines sources (step 204). In other words, catalog program 144 determines sources such as social media websites, forums, product blogs, review websites, podcasts, and the like, for monitoring product trends. In an embodiment, the sources are online, text based sources and are accessible by catalog program 144 via the Internet. In another embodiment, the sources are online, audio based sources and are accessible by catalog program 144 via the Internet. In yet another embodiment, the sources are offline, text based sources and are accessible by catalog program 144 via a memory (i.e., content from the sources is stored to the memory by a user). In an embodiment, catalog program 144 determines sources on server device 120 via network 110. For example, “Joe” uses a laptop computer to read a hunting and fishing blog created by several well-known outdoorsmen and women as well as a hunting forum and a fishing forum.

In an embodiment, catalog program 144 ranks sources (step 206). In other words, catalog program 144 ranks the determined sources based on popularity, quality, importance, and the like. In an embodiment, catalog program 144 determines popularity and quality by using available data from a ranking website. In another embodiment, catalog program 144 determines popularity and quality based on the number of visitors a source has over a time period. According to an embodiment of the present invention, catalog program 144 determines the importance of a source based on attributes such as the owner of the source and the contributors to the source (e.g., a source whose primary contributor is a world-class fisherman is more important than a source run by an amateur angler). In an embodiment, catalog program 144 ranks source on server device 120 and stores the ranking to information repository 142 on client device 140. For example, “Joe” considers the blog as the best source of information followed by the hunting forum and then the fishing forum.

In an embodiment, catalog program 144 extracts concepts (step 208). In other words, catalog program 144 extracts key concepts from the ranked sources (i.e., social media websites, blogs, etc.) related to the product of interest for creating a knowledge graph. In an embodiment, catalog program 144 uses keyword extraction to extract key concepts from the ranked sources. In an embodiment, keyword extraction is the automatic identification of terms that best describe the subject of a document such as an e-mail. “Key phrases”, “key terms”, “key segments”, or just “keywords” are the terminology which is used for defining the terms that represent the most relevant information contained in the document. Although the terminology is different between “key phrases”, “key terms”, “key segments”, and “keywords”, the function is the same: characterization of the topic discussed in a document. The task of keyword extraction is an important tool in text mining, information retrieval, and NLP. According to an embodiment of the present invention, key concepts include product taxonomy (i.e., classification), attributes, synonyms for the key concepts, brands, usage concepts, and usage occasions. In an embodiment, catalog program 144 extracts key concepts from the ranked sources and stores the key concepts to information repository 142 on client device 140. For example, the following key concepts are extracted for the socks “Joe” is researching: lightweight material, warmest available, three lengths, northern winters, Alaska, Canada, Upper Peninsula of Michigan, heavy weight, only up to size ten, multiple colors, brand ‘A’, brand 13′, brand ‘C’, revolutionary material, non-itch, scratchy, remain warm when wet, highest breathability factor, thin but warm, etc.

In an embodiment, catalog program 144 extracts relationships (step 210). In other words, catalog program 144 extracts relationships between the extracted key concepts. In an embodiment, catalog program 144 uses machine learning to extract the relationships. According to an embodiment of the present invention, machine learning is a field of computer science that gives computers the ability to learn without being explicitly programmed. Evolved from the study of pattern recognition and computational learning theory in artificial intelligence, machine learning explores the study and construction of algorithms that can learn from and make predictions on data—such algorithms overcome following strictly static program instructions by making data-driven predictions or decisions, through building a model from sample inputs. Machine learning is employed in a range of computing tasks where designing and programming explicit algorithms with good performance is difficult or infeasible; example applications include e-mail filtering, detection of network intruders or malicious insiders working towards a data breach, optical character recognition (OCR), learning to rank, and computer vision. Machine learning is closely related to (and often overlaps with) computational statistics, which also focuses on prediction-making using computers. Machine learning is sometimes conflated with data mining, where the latter subfield focuses more on exploratory data analysis and is known as unsupervised learning. Machine learning can also be unsupervised and be used to learn and establish baseline behavioral profiles for various entities and then used to find meaningful anomalies. In an embodiment, extracted relationships include “is a synonym of”, “goes well with”, “utilizes”, “incompatible with”, “usable in <area>”, “requires”, “available in”, “replaces”, “like”, “is a feature”, “sold in”, “is”, “better than”, etc. For example, the sock research by “Joe” results in several relationships.

In an embodiment, catalog program 144 creates triples (step 212). In other words, catalog program 144 uses the extracted key concepts and relationships to form triples between the concepts. In an embodiment, a triple is a set of three entities that codifies a statement about a subject (i.e., a product in a product catalog). In an embodiment, the statement is in the form of a subject-predicate-object expression. In another embodiment, the statement is in the form of key concept-relationship-key concept. According to an embodiment of the present invention, catalog program 144 uses natural language patterns such as those in open information extraction, which refers to the extraction of relation tuples (i.e., triples). In an embodiment, catalog program 144 creates triples from the extracted key concepts and relationships stored to information repository 142 on client device 140. For example, several triples are created based on the sock research done by “Joe”: <brand ‘B’—usable in—Alaska >, <brand ‘A’—utilizes—revolutionary material >, <thin but warm—replaces—heavy weight >, <non-itch—is a feature of—brand ‘C’>, <light weight material—available in—multiple colors >, <brand ‘A’—sold in—Upper Peninsula of Michigan >, <remain warm when wet—better than—scratchy >, <brand ‘A’—is—waterproof >, and <brand ‘B’ and ‘C’—incompatible with—only up to size ten >.

In an embodiment, catalog program 144 weights triples (step 214). In other words, catalog program 144 weights the triples based on the source(s) from where the key concepts were extracted. According to an embodiment of the present invention, a weighting factor is a weight given to a data point to assign it a heavier importance in a group. In an embodiment, catalog program 144 adds a ten percent weight if one component of a triple is extracted from the highest ranked source. In the embodiment, catalog program 144 adds a twenty-five percent weight if two components of a triple are extracted from the highest ranked source. In another embodiment, a user can adjust weighting percentages to any value desired by the user, including a negative weight. In yet another embodiment, catalog program 144 can determine a weighting scheme. In an embodiment, catalog program 144 weights the created triples and stores the weighted triples to information repository 142 on client device 140. For example, the triples created from the hunting and fishing blog read by “Joe” have a twenty percent weight added to give them more importance than the triples from the hunting forum or the fishing forum also read by “Joe”.

In an embodiment, catalog program 144 creates a knowledge graph (step 216). In other words, catalog program 144 annotates unstructured text with product related concepts and relationships from the ranked sources to create a knowledge graph. In an embodiment, catalog program 144 uses Natural Language Processing (NLP) to determine unstructured text and product related concepts in the ranked sources. According to an embodiment of the present invention, NLP is a field of computer science, artificial intelligence and computational linguistics concerned with the interactions between computers and human (i.e., natural) languages. NLP techniques known in the art include dictionary-based and topic-modeling approaches. In an embodiment, catalog program 144 creates a knowledge graph, using NLP, from the ranked sources on server device 120 and stores the created knowledge graph to information repository 142 on client device 140. For example, a knowledge graph related to “the best socks for the outdoors” is created on the laptop owned by “Joe”.

In an embodiment, catalog program 144 embeds into knowledge base (step 218). In other words, catalog program 144 embeds the created knowledge graph into an existing knowledge base. In an embodiment, the existing knowledge base includes substantially more triples than the number of weighted triples in the created knowledge graph such that the existing knowledge base supplements the created knowledge graph with additional data. In an embodiment, catalog program 144 embeds the created knowledge graph into an existing knowledge base on server device 120 and stores the existing knowledge base with the embedded created knowledge graph to information repository 142 on client device 140. For example, a knowledge graph concerning socks is embedded into an existing knowledge base of outdoor products.

In an embodiment, catalog program 144 identifies new attributes (step 220). In other words, catalog program 144 uses the knowledge base with the embedded knowledge graph to identify new attributes (i.e., key concepts) of the product of interest that were not present in the ranked sources. According to an embodiment of the present invention, catalog program 144 uses NLP to identify new attributes for the product in the existing knowledge base. In an embodiment, catalog program 144 identifies new attributes in the existing knowledge base stored to information repository 142 on client device 140. For example, new attributes discovered for the socks being researched by “Joe” include: ankle/crew/calf lengths, socks, warmth, thicker, proprietary material, feet, competition, wool, new material, etc.

In an embodiment, catalog program 144 identifies new relationships (step 222). In other words, catalog program 144 uses the knowledge base with the embedded knowledge graph to identify new relationships of the product of interest. According to an embodiment of the present invention, catalog program 144 identifies new relationships by considering the closest (i.e., densest) neighborhood in the knowledge base with the embedded knowledge graph that includes all the embedded triples. In an embodiment, catalog program 144 identifies new relationships in the knowledge base stored to information repository 142 on client device 140. For example, new relationships for the socks researched by “Joe” include: <socks—worn on—feet >, <lengths—include—ankle/crew/calf >, <thicker—better for—warmth >, <proprietary material—warmer than—wool >, <new material—dries faster—competition >, and <brand ‘A’—better value—brand ‘B’ and ‘C’>.

In an embodiment, catalog program 144 sends recommendation (step 224). In other words, catalog program 144 sends a recommendation based on the new identified attributes and relationships. In a first embodiment, the recommendation is sent to a product manager for the catalog. In the first embodiment, the recommendation may be to (i) update a current product catalog with a new item based on the tracking of current trends as previously described above, (ii) to update an item description in a product catalog with a new attribute identified by the tracking of current trends as previously described above, or (iii) to remove an existing item in a product catalog. In a second embodiment, the recommendation may be sent to a user shopping for a product of interest. In the second embodiment, the recommendation may be to consider purchasing the product of interest based on unique features of the product of interest not found in other products. In an embodiment, catalog program 144 sends a recommendation to (i) a user of client device 140 (e.g., a product manager of a catalog) or (ii) a user of computing device 130 (e.g., a user shopping for a new product). For example, “Joe” receives a recommendation to by the brand ‘A’ socks because brand ‘A’ is waterproof (identified from the knowledge graph of ranked sources) and are a better value that brands ‘B’ and ‘C’ (identified from embedding triples into the existing knowledge base).

In an alternate embodiment, based on the new identified attributes and relationships, catalog program 144 automatically updates a product catalog and notifies the product manager of the update. In the alternate embodiment, the automatic update may include the addition of a new item to the product catalog, an update of an item description of an existing item in the product catalog, and the removal of an existing item from the product catalog.

In a first additional example, consider the following excerpt concerning leather satchels from a blog posting by a fashion expert:

“Leather satchels are classy and go well with business suits. Typically, backpacks do not go well with business attire; however, leather backpacks exemplify the look of the young professional without compromising on class.”

A knowledge graph can be extracted from the blog posting as follows: <satchel—type of—bag >, <backpack—type of—bag >, <leather satchels—are—classy >, <classy—type—positive attribute >, <classy—goes well with—business suit >, <leather satchel—goes well with—business suit >, <backpack—not go well with—business suit >, <leather backpack—type—backpack >, <leather backpack—exemplifies—young professional >, and <leather backpacks—are—classy >. A user doing an Internet query for a “bag to coordinate with my suit” may receive a recommendation to consider a leather satchel based on the knowledge graph that determines <leather satchel—goes well with—business suit >. Since the knowledge graph also determined that <classy—goes well with—business suit > and <leather backpacks—are—classy >, the user may also receive a recommendation to consider a leather backpack. This first additional example identifies “product-to-product” trends between two similar but distinct products as determined by tracking trends from social media websites.

In a second additional example, consider the following excerpt from a social media comment by a well-respected music reporter concerning a current pop superstar:

“Out and about in the concrete jungle that is New York City, the superstar zipped into an all-over camo look that was ready for any terrain. To match her oversize ‘Butt’ brand Canada goose-down, camouflage printed parka . . . ”

A knowledge graph can be extracted from the social media comment as follows: <New York City—is—concrete jungle >, <superstar—wore—camo look >, <superstar—wore—parka >, <parka—brand—‘Brrrr’>, <parka—pattern—camouflage >, <parka—type—jacket >, <parka—attribute—camo look >, and <camo look—pattern—camouflage >. From the completed triples in the knowledge graph, ‘camo look’ is identified as a camouflage pattern and a recommendation can be sent to a product manager of the catalog to include clarification, if needed, that ‘camo’ is short for a camouflage pattern. This second additional example identifies “product-to-attribute” information that can be determined from tracking trends from social media websites.

In a third additional example, consider a scenario where a user wants to buy a new smartphone that takes excellent “selfies” (i.e., self-portraits). The user searches various social media websites looking for opinions on the best selfie smartphone which results in the following knowledge graph: <selfie—is—silly >, <silly—type—negative >, <silly—opposite—smart >, <smart—type—positive >, <smart—read—magic/realism >, <book title ‘BT’—genre—magic/realism >, <author ‘AU’—name—book title ‘BT’>, <selfie expert—is—smartphone ‘X’>, <‘X’—includes—twelve megapixel camera >, and <‘X’—rating—nine out of ten >.

From the above knowledge graph concerning the best selfie smartphone, the knowledge graph can identify the closest negative attribute associated with the smartphone: <selfie—is—silly > and <silly—type—negative >. The knowledge graph also identifies the opposite of the negative attribute to get a positive attribute: <silly—opposite—smart > and <smart—type—positive >. A retailer can make a recommendation to a user based on the following information in the knowledge graph: <smart—read—magic/realism >, <book title ‘BT’—genre—magic/realism >, <author ‘AU’—name—book title ‘BT’>. Here, the recommendation can be to read a book written by ‘AU’ or the recommendation can be to read the specific book ‘BT’. This third additional example identifies “product-to-social” trends (i.e., how products affect social behaviors of a user) as determined by tracking trends from social media websites.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Having described embodiments of an approach for representing an e-mail with an image, it is noted that modifications and variations may be made by persons skilled in the art in light of the above teachings. It is therefore to be understood that changes may be made in the particular embodiments disclosed which are within the scope of the invention as outlined by the appended claims.

FIG. 3 depicts computer system 300, which is an example of a system that includes catalog program 144. Computer system 300 includes processor(s) 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 6305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touchscreen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
receiving, by one or more computer processors, an input from a user, wherein the input is associated with a product of interest to the user;
determining, by one or more computer processors, a plurality of sources that monitor product trends;
ranking, by one or more computer processors, the plurality of sources that monitor product trends;
extracting, by one or more computer processors, a plurality of key concepts associated with the product of interest from the ranked sources;
extracting, by one or more computer processors, relationships from the extracted plurality of key concepts;
creating, by one or more computer processors, a plurality of triples between the extracted key concepts using the extracted relationships; and
weighting, by one or more computer processors, the created triples based on the ranking of the plurality of sources.

2. The method of claim 1, further comprising:
creating, by one or more computer processors, a knowledge graph by annotating unstructured text from the ranked sources with the extracted relationships;
embedding, by one or more computer processors, the knowledge graph and the weighted triples into an existing knowledge base;
identifying, by one or more computer processors, a plurality of new attributes based on the existing knowledge base with the embedded knowledge graph and weighted triples;
identifying, by one or more computer processors, a plurality of new relationships of the product of interest based on a densest neighborhood in the existing knowledge base that includes the embedded knowledge graph with the embedded weighted triples; and
sending by one or more computer processors, a recommendation.

3. The method of claim 1, wherein the plurality of sources that monitor product trends are selected from the group consisting of: social media websites, forums, product blogs, review websites, and podcasts.

4. The method of claim 1, wherein the ranking of the plurality of sources that monitor product trends is based on a popularity, a quality, and an importance of each source in the plurality of sources.

5. The method of claim 1, wherein:
extracting the plurality of key concepts from the ranked sources utilizes keyword extraction; and
extracting relationships from the extracted plurality of key concepts utilizes machine learning.

6. The method of claim 1, wherein a triple of the plurality of triples is a set of two key concepts of the extracted key concepts associated with one another by a relationship of the extracted relationships.

7. The method of claim 2, wherein creating the knowledge graph utilizes natural language processing.

8. The method of claim 2, wherein the recommendation is selected from the group consisting of: a first recommendation sent to a product manager of a product catalog to update the product catalog with the product of interest, a second recommendation sent to the product manager of the product catalog to update a description of the product of interest in the product catalog with a new attribute, a third recommendation sent to the product manager of the product catalog to remove an existing item from the product catalog, and a fourth recommendation to the user to purchase the product of interest based on a unique feature available in the product of interest.

9. A computer program product comprising:
one or more computer readable storage media; and
program instructions stored on the one or more computer readable storage media, the program instructions comprising:
program instructions to receive an input from a user, wherein the input is associated with a product of interest to the user;
program instructions to determine a plurality of sources that monitor product trends;
program instructions to rank the plurality of sources that monitor product trends;
program instructions to extract a plurality of key concepts associated with the product of interest from the ranked sources;
program instructions to extract relationships from the extracted plurality of key concepts;
program instructions to create a plurality of triples between the extracted key concepts using the extracted relationships; and
program instructions to weight the created triples based on the ranking of the plurality of sources.

10. The computer program product of claim 9, further comprising program instructions stored on the one or more computer readable storage media, to:
create a knowledge graph by annotating unstructured text from the ranked sources with the extracted relationships;
embed the knowledge graph and the weighted triples into an existing knowledge base;
identify a plurality of new attributes based on the existing knowledge base with the embedded knowledge graph and weighted triples;
identify a plurality of new relationships of the product of interest based on a densest neighborhood in the existing knowledge base that includes the embedded knowledge graph with the embedded weighted triples; and
send a recommendation.

11. The computer program product of claim 9, wherein the plurality of sources that monitor product trends are selected from the group consisting of: social media websites, forums, product blogs, review websites, and podcasts.

12. The computer program product of claim 9, wherein the ranking of the plurality of sources that monitor product trends is based on a popularity, a quality, and an importance of each source in the plurality of sources.

13. The computer program product of claim 9, wherein:
extracting the plurality of key concepts from the ranked sources utilizes keyword extraction; and
extracting relationships from the extracted plurality of key concepts utilizes machine learning.

14. The computer program product of claim 9, wherein a triple of the plurality of triples is a set of two key concepts of the extracted key concepts associated with one another by a relationship of the extracted relationships.

15. The computer program product of claim 10, wherein creating the knowledge graph utilizes natural language processing.

16. The computer program product of claim 10, wherein the recommendation is selected from the group consisting of: a first recommendation sent to a product manager of a product catalog to update the product catalog with the product of interest, a second recommendation sent to the product manager of the product catalog to update a description of the product of interest in the product catalog with a new attribute, a third recommendation sent to the product manager of the product catalog to remove an existing item from the product catalog, and a fourth recommendation to the user to purchase the product of interest based on a unique feature available in the product of interest.

17. A computer system comprising:
one or more computer processors;
one or more computer readable storage media; and
program instructions stored on the one or more computer readable storage media for execution by at least one of the one or more computer processors, the program instructions comprising:
program instructions to receive an input from a user, wherein the input is associated with a product of interest to the user;
program instructions to determine a plurality of sources that monitor product trends;
program instructions to rank the plurality of sources that monitor product trends;
program instructions to extract a plurality of key concepts associated with the product of interest from the ranked sources;
program instructions to extract relationships from the extracted plurality of key concepts;
program instructions to create a plurality of triples between the extracted key concepts using the extracted relationships; and
program instructions to weight the created triples based on the ranking of the plurality of sources.

18. The computer system of claim 17, further comprising program instructions stored on the one or more computer readable storage media for execution by at least one of the one or more computer processors, to:
create a knowledge graph by annotating unstructured text from the ranked sources with the extracted relationships;
embed the knowledge graph and the weighted triples into an existing knowledge base;
identify a plurality of new attributes based on the existing knowledge base with the embedded knowledge graph and weighted triples;
identify a plurality of new relationships of the product of interest based on a densest neighborhood in the existing knowledge base that includes the embedded knowledge graph with the embedded weighted triples; and
send a recommendation.

19. The computer system of claim 17, wherein the plurality of sources that monitor product trends are selected from the group consisting of: social media websites, forums, product blogs, review websites, and podcasts.

20. The computer system of claim 17, wherein the ranking of the plurality of sources that monitor product trends is based on a popularity, a quality, and an importance of each source in the plurality of sources.
